(19) United States
(12) Patent Application Publication
(10) Pub. No.: US 2013/0339876 A1
(43) Pub. Date: Dec. 19, 2013

(54) INFORMATION PROCESSING APPARATUS, INFORMATION PROCESSING METHOD, AND PROGRAM

(71) Applicant: PFU LIMITED, Kahoku-shi (JP)

(72) Inventors: Masahiro Fujitsuka, Kahoku-shi (JP); Kyoichi Nishi, Kahoku-shi (JP); Takashi Kubota, Kahoku-shi (JP)

(73) Assignee: PFU LIMITED, Kahoku-shi (JP)

(21) Appl. No.: 13/859,172

(22) Filed: Apr. 9, 2013

(30) Foreign Application Priority Data
Jun. 13, 2012 (JP) 2012-133586

(51) Int. Cl. H04L 29/06

(52) U.S. Cl. CPC H04L 65/403
USPC 715/753

(57) ABSTRACT

An information processing apparatus according to an aspect of the present invention includes a group information holding unit that holds group information for identifying content and a target of communication which are associated with a group set for a job, the content being a target of the job, the target of communication being related to the job, and a display control unit that switches, in response to specification of a group, display states of the content and the target of communication associated with the specified group based on the group information.

### CROSS-REFERENCE TO RELATED APPLICATION

This application is based upon and claims the benefit of priority of the prior Japanese Patent Application No. JP2012-133586, filed on Jun. 13, 2012, the entire contents of which are incorporated herein by reference.

### FIELD

The present invention relates to technologies of an information processing apparatus, an information processing method, and a program.

### BACKGROUND

There is a technology of distinguishing between display states of windows and saving the display states on a per job basis so as to enable reconstruction of the window state for each of different jobs (see Japanese Patent Application Publication No. 2005-084699). There is also a technology of grouping a plurality of windows into control tiles in a taskbar, and enabling switching of display (see Japanese Patent Application Publication No. 2004-280777).

When performing a job using a PC (personal computer) or the like, one often inputs, edits or views content on the screen of the PC while communicating with people involved in the job via telephone, mails, groupware, SNS (social networking service) and the like. Conventionally, a user carrying out a plurality of jobs separately performs switching of content the user is working on and switching of communication related to the job, and there is an issue that the efficiency of switching between jobs including communication is poor.

### SUMMARY

The present invention adopts the following configuration to solve the issue described above.

That is, an information processing apparatus according to an aspect of the present invention includes a group information holding unit that holds group information for identifying content and a target of communication which are associated with a group set for a job, the content being a target of the job, the target of communication being related to the job, and a display control unit that switches, in response to specification of a group, display states of the content and the target of communication associated with the specified group based on the group information.

Moreover, other embodiments of the information processing apparatus according to an aspect described above may include an information processing system that achieves each of the structures described above, an information processing method, a program, and a recording medium having such program recorded therein that can be read by a computer, another device, a machine or the like.

Here, the non-transitory recording medium that can be read by a computer or the like is a medium that stores information such as a program electrically, magnetically, optically, mechanically or by chemical action.

Additionally, the information processing system may be achieved by one or more information processing apparatuses.

### BRIEF DESCRIPTION OF THE DRAWINGS

FIG. 1 illustrates an example of a hardware configuration of an information processing apparatus according to an embodiment;

FIG. 2 illustrates an example of a functional configuration of an information processing apparatus according to an embodiment;

FIG. 3 illustrates an example of a category group object according to an embodiment;

FIG. 4 illustrates an example of a content object according to an embodiment;

FIG. 5A illustrates an example of a people panel according to an embodiment;

FIG. 5B illustrates an example of a people object according to an embodiment;

FIG. 6A illustrates an example of a dashboard object according to an embodiment;

FIG. 6B illustrates an example of an SNS group object according to an embodiment;

FIG. 7 illustrates an example of a screen of an output device according to an embodiment;

FIG. 8 illustrates an example of a display of a dashboard according to an embodiment;

FIG. 9 illustrates an example of a display of people according to an embodiment;

FIG. 10 illustrates an example of a display at the time of cancellation of content from a group according to an embodiment;

FIG. 11 illustrates an example of a procedure regarding update of a state of a category group object by an information processing apparatus of an embodiment;

FIG. 12 illustrates an example of a procedure regarding deletion of a category group object by an information processing apparatus of an embodiment;

FIG. 13 illustrates an example of a procedure regarding update of a state of a content object by an information processing apparatus of an embodiment;

FIG. 14 illustrates an example of a procedure regarding update of a state of a people object by an information processing apparatus of an embodiment;

FIG. 15 illustrates an example of a procedure regarding update of a state of a dashboard object by an information processing apparatus of an embodiment;

FIG. 16 illustrates an example of a procedure regarding confirmation of content exchange by an information processing apparatus of an embodiment.

### DESCRIPTION OF EMBODIMENT

Hereinafter, an embodiment according to an aspect of the present invention (hereinafter, also referred to as “present embodiment”) will be described with reference to the drawings.

However, the present embodiment described below is merely an example of the present invention in every aspect, and is not to limit the scope of the present invention.

Various modifications and alterations are, of course, possible without departing from the scope of the present invention. That is, a specific configuration according to the embodiment may be appropriately adopted at the time of implementation of the present invention.

Moreover, data appearing in the present embodiment is described by a natural language, but more specifically, it is specified by a pseudo-language, a command, a parameter, a machine language or the like that can be recognized by a computer.

§1 Information Processing Apparatus

An information processing apparatus of the present embodiment holds group information for identifying content and a target of communication which are associated with a group set for a job, in which the content is a target of the job and the target of communication is related to the job. When a group is specified, the information processing apparatus of the present embodiment switches the display state of the content associated with the specified group and the target of communication based on the group information.

Here, the content is data which a user can input, edit or view using the information processing apparatus, for example. The content is, for example, an image file, a document file, a spreadsheet file or the like.

Also, the target of communication is a party or group with whom communication via telephone, emails, groupware, SNS and the like is possible. For example, the target of communication is specified by the telephone number, the email address, the account name, the group name or the like. Thus, the target of communication is displayed using contact information including the email address, for example.

Moreover, a group which is the target of communication is a group that is used by a communication tool for group communication, such as a group to which a user belongs in an SNS, for example. On the other hand, a “group set for a job” in the present embodiment is used for associating content which is the target of a job and the target of communication related to the job. Therefore, a group as a target of communication and the “group set for a job” in the present embodiment may be distinguished from each other.

Additionally, a group as a target of communication and the “group set for a job” in the present embodiment may have the same name or they may be named differently.

In the following, a group to which a user belongs in an SNS is taken as an example of the group as a target of communication. Moreover, in order to distinguish the “group set for a job” in the present embodiment and the group to which a user belongs in an SNS from each other, the group to which a user belongs on an SNS may also be referred to as an “SNS group”. Also, the “group set for a job” may also be referred to as a “category group”.

According to the information processing apparatus of the present embodiment, the group set for a job is associated with content which is the target of the job and the target of communication related to the job. Then, when a group is specified, the display states of the content and the target of communication that are associated with the specified group are switched.

Thus, according to the information processing apparatus of the present embodiment, the display state of content and the display state of a communication target that are conventionally switched separately can be switched collectively. Therefore, according to the information processing apparatus of the present embodiment, the efficiency of switching between jobs including communication can be increased.

Additionally, the information processing apparatus of the present embodiment may control display of content or a target of communication such that an area where the content or the target of communication is displayed is displayed with a color set for a group with which the content or the target of communication is associated.

Also, the information processing apparatus of the present embodiment may control display of content or a target of communication such that a group associated with the content or the target of communication and a receiving unit for receiving cancellation of association with the group are displayed in an area where the content or the target of communication is displayed. Then, the information processing apparatus of the present embodiment may cancel, in response to an operation on the receiving unit, association of content or a target of communication with a group related to the operation.

Furthermore, at the time of starting exchange of content with a target of communication, the information processing apparatus of the present embodiment may confirm whether or not to perform the exchange, by determining whether or not the content related to the exchange and the target of communication are associated with the same group.

Still further, in the case it is determined that the content related to the exchange and the target of communication are not associated with the same group, the information processing apparatus of the present embodiment may confirm whether or not to perform the exchange, by receiving a response regarding whether or not to allow the exchange.

In the present embodiment, an information processing apparatus capable of coping with the above is illustrated as an example.

<Example Hardware Configuration>

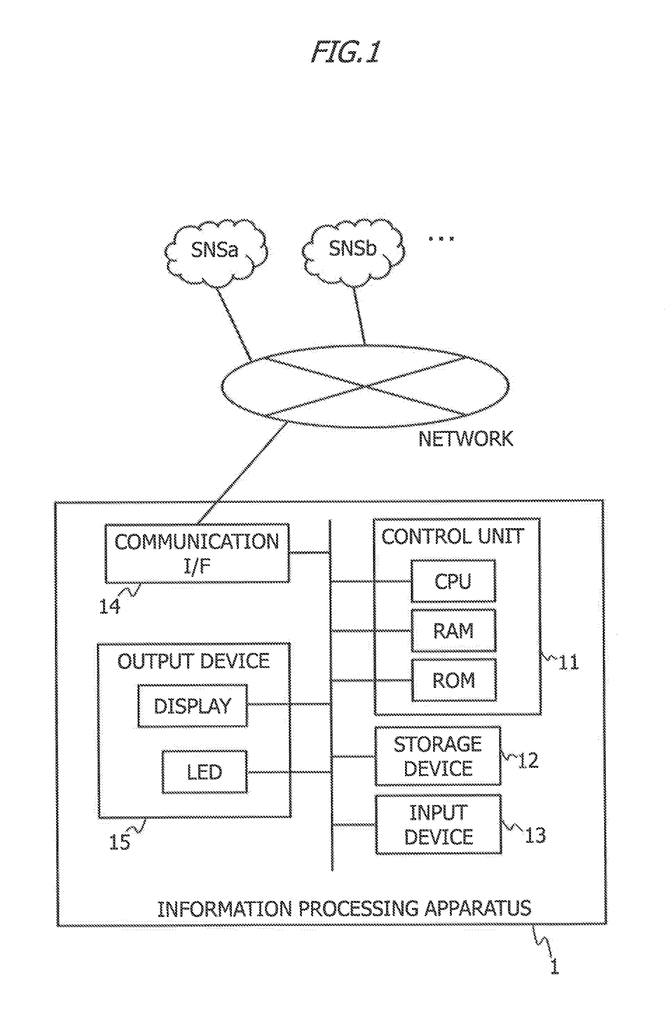

FIG. 1 illustrates an example of a hardware configuration of an information processing apparatus 1 of the present embodiment. As illustrated in FIG. 1, the information processing apparatus 1 of the present embodiment includes a control unit 11 including a CPU (Central Processing Unit), a RAM (Random Access Memory), a ROM (Read Only Memory) and the like, a storage device 12 that stores programs and the like to be executed by the control unit 11, an input device 13 such as a mouse, a keyboard or the like, a communication interface 14 for performing communication over a network, and an output device 15 including a display, an LED and the like. The control unit 11, the storage device 12, the input device 13, the communication interface 14 and the output device 15 are electrically connected. Additionally, in FIG. 1, the communication interface is written as “communication I/F”.

Furthermore, with respect to a concrete hardware configuration of the information processing apparatus 1, structural elements may be omitted, replaced or added as appropriate according to an embodiment. For example, the control unit 11 may include a plurality of processors.

Also, as the information processing apparatus 1, a PC (personal computer), a mobile phone, a smartphone, a tablet terminal and the like may be used, besides a terminal designed specifically for the service provided, for example.

Additionally, SNSa and SNSb in FIG. 1 indicate one or more servers providing an SNS. A user using the information processing apparatus 1 of the present embodiment is enabled to perform communication on the SNS by accessing the one or more servers (SNSa, SNSb and the like) providing the SNS.

<Example Functional Configuration>

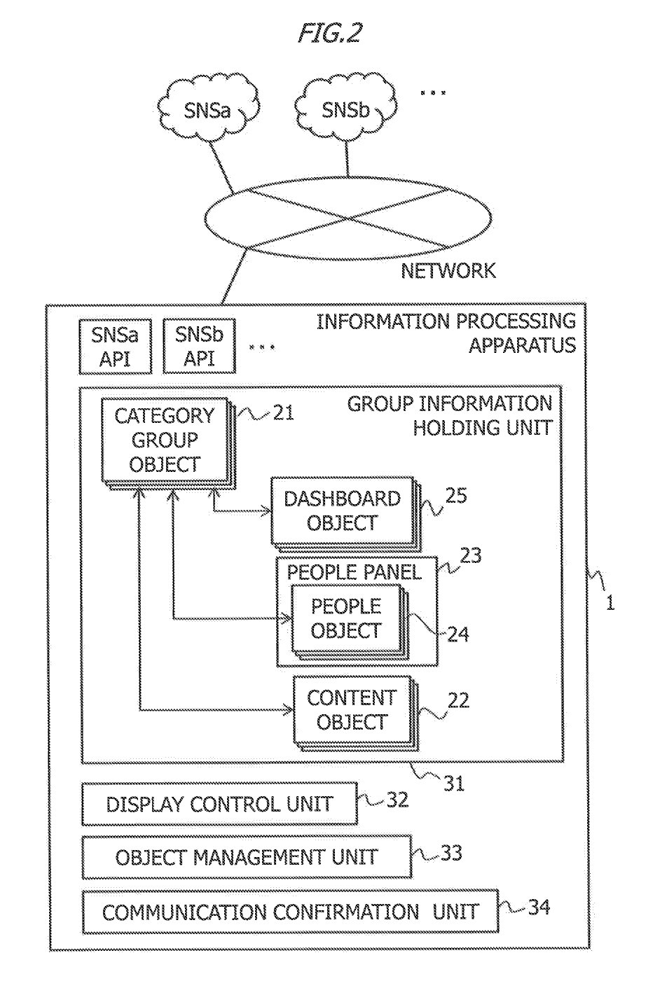

FIG. 2 illustrates an example of a functional configuration of the information processing apparatus 1 of the present embodiment.

By the CPU interpreting and executing various programs expanded on the RAM and controlling each structural element, the information processing apparatus 1 functions as an information processing apparatus including a group information holding unit 31, a display control unit 32, an object management unit 33 and a communication confirmation unit 34. Additionally, in the present embodiment, each of these functions is achieved by a general-purpose CPU. However, one or some or all of these functions may be achieved by one or more dedicated processors. Also, with respect to the functional configuration of the information processing apparatus 1, structural elements may be omitted, replaced or added as appropriate according to an embodiment.

The group information holding unit 31 holds group information for identifying content and a target of communication which are associated with a group set for a job, in which the content is a target of the job and the target of communication is related to the job. For example, in the present embodiment, the group information holding unit 31 holds a category group object 21, a content object 22, a people object 24 included in a people panel 23, and a dashboard object 25.

The category group object 21 is an object for holding information about a category group. In the present embodiment, the category group object 21 associates the content object 22, the people object 24 and the dashboard object 25 described later.

Also, the content object 22 is an object for holding information about content which is a target of a job. In the present embodiment, the category group with which content is associated, the display state, the coordinates for display, the size and the like are managed based on the content object 22.

Furthermore, the people object 24 is an object for holding information about the other party (a person) with whom a user communicates. In the present embodiment, information such as the telephone number or the email address of the other party of communication is managed based on the people object 24. Additionally, in the following, the information about the other party (a person) with whom a user communicates may be simply referred to as “people”.

Furthermore, the dashboard object 25 is an object for holding information about a dashboard for displaying the substance of communication on an SNS. In the present embodiment, the substance of communication between users belonging to an SNS group is displayed in a timeline based on the dashboard object 25.

That is, in the present embodiment, the information indicated by the category group object 21 corresponds to the group information according to the present invention. Also, a target whose display state or the like is to be managed based on the content object 22 corresponds to the content according to the present invention. Furthermore, the other party or group of communication that is performed based on the people object 24 and the dashboard object 25 corresponds to the target of communication according to the present invention. In the following, these objects will be described with reference to the drawings.

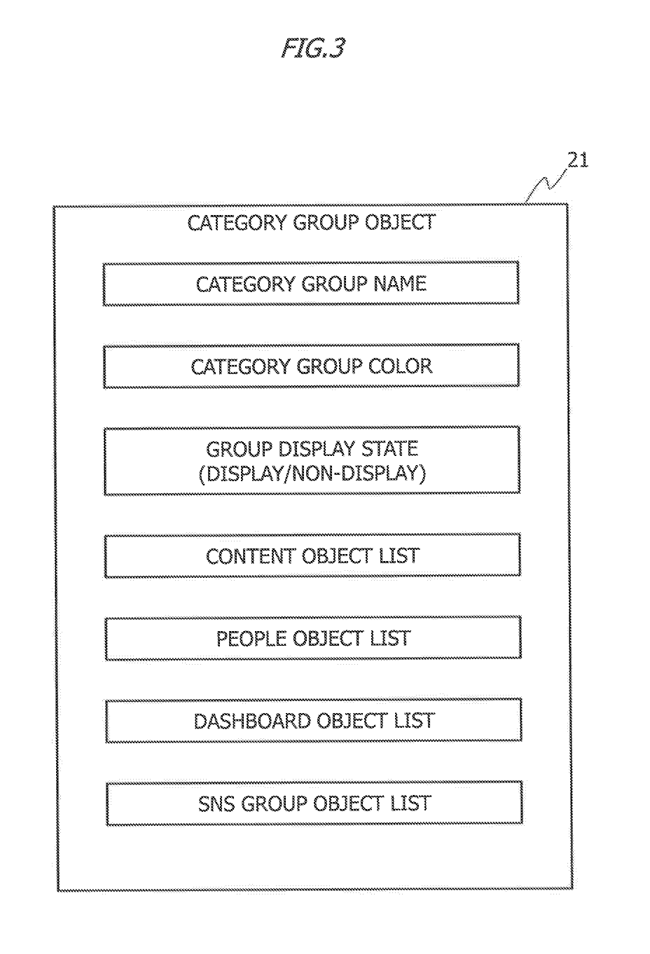

FIG. 3 illustrates an example of the category group object 21 according to the present embodiment. As illustrated in FIG. 3, in the present embodiment, the category group object 21 is an object that includes a category group name, a category group color, a group display state, a content object list, a people object list, a dashboard object list and an SNS group object list.

The category group name is the name of a category group. The category group name is used by a user to identify a category group.

The category group color is the color set for a category group. As the number of category groups that are set increases, it becomes more and more difficult for a user to identify a category group to which content and a target of communication belong. Thus, the information processing apparatus 1 of the present embodiment displays the category group color together with content and a target of communication to thereby enable the user to easily identify the category group to which the content and the target of communication belong.

The group display state relates to the display state of content and a target of communication belonging to the category group. In the present embodiment, the display states of content, people and dashboard belonging to the category group are decided based on the group display state. However, the display state is not limited to two states. For example, three or more states may be set with respect to the display state by using the degree of transparency.

The content object list is a list of pieces of content belonging to a category group. That is, the content object list indicates the content object(s) 22 associated with the category group object 21.

The people object list included in the category group object 21 is a list of people belonging to a category group identified based on the category group object 21. That is, the people object list included in the category group object 21 indicates the people object(s) 24 associated with the category group object 21.

The dashboard object list is a list of dashboards belonging to a category group. That is, the dashboard object list indicates the dashboard object(s) 25 associated with the category group object 21.

The SNS group object list included in the category group object 21 is a list of SNS groups displayed on a dashboard belonging to a category group identified based on the category group object 21. That is, the SNS group object list included in the category group object 21 indicates the SNS group(s) displayed on a dashboard included in the dashboard object list.

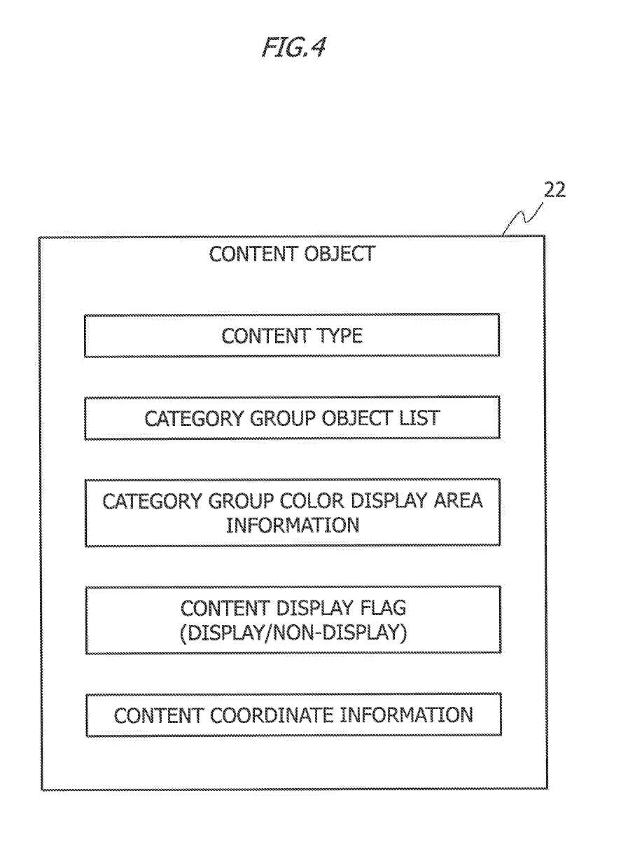

FIG. 4 illustrates an example of the content object 22 of the present embodiment. As illustrated in FIG. 4, in the present embodiment, the content object 22 includes a content type, a category group object list, category group color display area information, a content display flag and content coordinate information.

The content type indicates the type of content. In the present embodiment, an image file, a document file, a spreadsheet file and the like may be cited as the content types, for example.

The category group object list included in the content object 22 is a list of category groups to which content identified based on the content object 22 belongs. That is, the category group object list included in the content object 22 indicates the category group object(s) 21 to which the content object 22 belongs.

The category group color display area information included in the content object 22 is information about an area (a category group color display area) that displays a color set for a category group to which content identified based on the content object 22 belongs.

The content display flag indicates the display state of content. The content display flag is used to decide whether or not the content is to be displayed.

The content coordinate information is information about the coordinates of an area where content is to be displayed (content coordinates) and the size of the area (width, height). The content coordinate information is used to identify an area where the content is to be displayed.

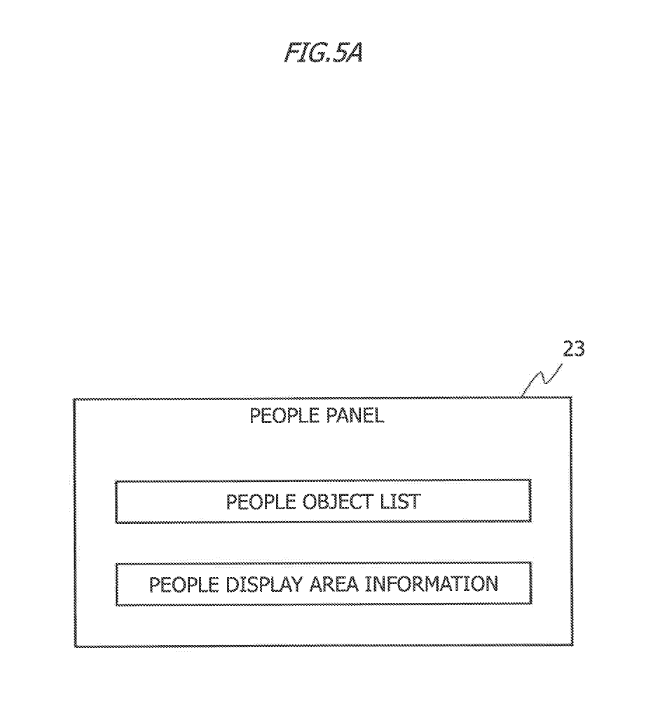

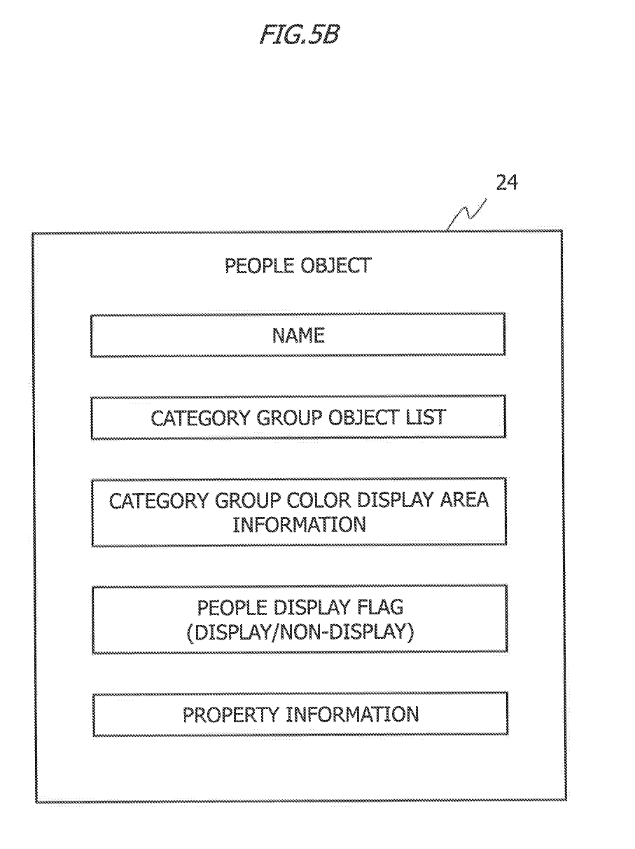

FIG. 5A illustrates an example of the people panel 23 according to the present embodiment. The people panel 23 relates to an area where people are lined up and displayed. As illustrated in FIG. 5A, in the present embodiment, the people panel 23 includes a people object list and people display area information.

The people object list included in the people panel 23 is a list of people managed by the information processing apparatus 1. That is, the people object list included in the people panel 23 indicates the people object(s) 24 held by the group information holding unit 31.

The people display area information is information about an area (a people display area) where people identified based on the people object 24 whose people display flag, described later, is set to “display” are displayed.

FIG. 5B illustrates an example of the people object 24 according to the present embodiment. As illustrated in FIG. 5B, in the present embodiment, the people object 24 includes a name, a category group object list, category group color display area information, a people display flag and property information.

The name included in the people object 24 is the name, the title or the like of the other party of communication that is performed based on the people object 24.

The category group object list included in the people object 24 is a list of category groups to which people identified based on the people object 24 belong. That is, the category group object list included in the people object 24 indicates the category group object(s) 21 to which the people object 24 belongs.

The category group color display area information included in the people object 24 is information related to an area (a category group color display area) that displays a color set for a category group to which the people identified based on the people object 24 belong.

The people display flag indicates the display state of people. The people display flag is used to decide whether or not the people are to be displayed.

The property information includes information such as the affiliation of the other party of communication, the URL (Uniform Resource Locator), the email address, the telephone number, the SNS in which the other party is registered, and the like. The property information relates to the details of people related to a target object.

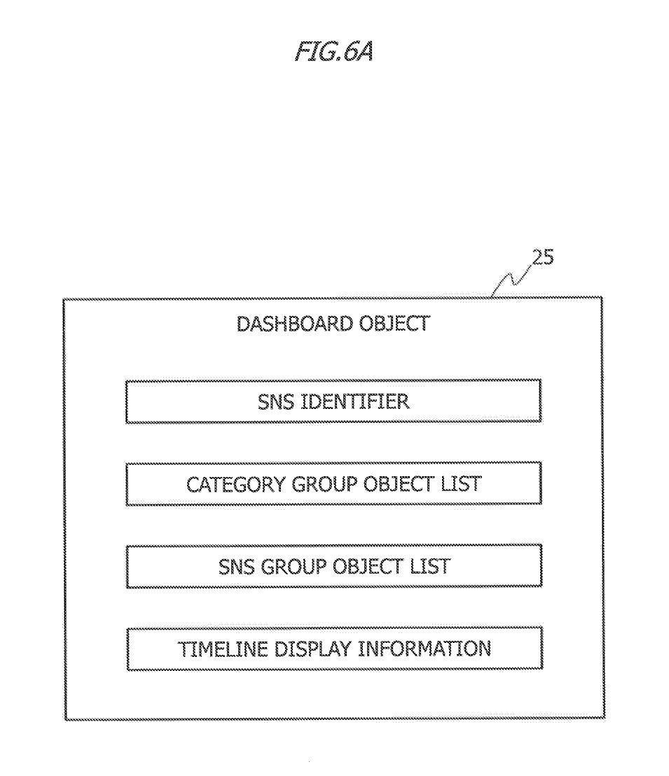

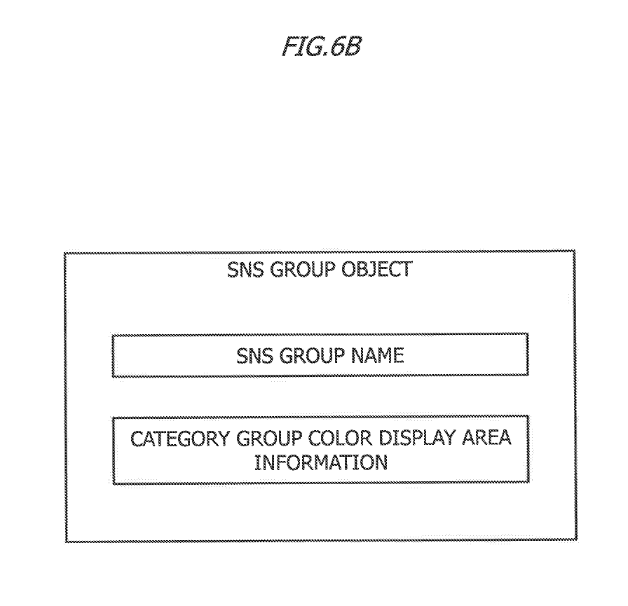

FIG. 6A illustrates an example of the dashboard object 25 according to the present embodiment. As illustrated in FIG. 6A, in the present embodiment, the dashboard object 25 includes an SNS identifier, a category group object list, an SNS group object list and timeline display information. In the present embodiment, an SNS group as the target of communication is associated with a category group by the dashboard object 25.

The SNS identifier is used to identify an SNS connected to the dashboard.

The category group object list included in the dashboard object 25 is a list of category groups to which the dashboard identified based on the dashboard object 25 belongs. That is, the category group object list included in the dashboard object 25 indicates the category group object(s) 21 to which the dashboard object 25 belongs.

The SNS group object list is a list of SNS groups for which the substance of communication is displayed on the dashboard. Additionally, in the present embodiment, an SNS group object, described later, is used to hold information about the SNS group.

The timeline display information is information about an area where the substance of communication is displayed in a timeline on the dashboard. Additionally, the substance of communication in an SNS group included in the SNS group object list is displayed in a timeline in this area on the dashboard.

FIG. 6B illustrates an example of the SNS group object according to the present embodiment. As illustrated in FIG. 6B, in the present embodiment, the SNS group object includes an SNS group name and category group color display area information.

The SNS group name indicates the name of an SNS group. The SNS group is a group to which a user belongs in SNSa, SNSb or the like, for example.

The category group color display area information included in the SNS group object is information related to an area (a category group color display area) that displays a color set for a category group to which the SNS group identified based on the SNS group object belongs.

The group information holding unit 31 holds various types of information based on these objects. Here, the group information holding unit 31 may be provided in the storage device 12 or in the RAM in the control unit 11 or in both of them. For example, the information processing apparatus 1 may use the RAM as the group information holding unit 31 in the case of temporarily holding information. Also, the information processing apparatus 1 may use the storage device 12 as the group information holding unit 31 in the case of permanently holding the information.

Additionally, in the present embodiment, information to be held by the group information holding unit 31 is represented by an object. That is, the information processing apparatus 1 uses data which is represented by an object. However, data that can be used by the information processing apparatus 1 according to the present embodiment is not limited to such data which is represented by an object, and it may also be data in a table format, for example. The format of data used by the information processing apparatus 1 is selected as appropriate according to the embodiment.

Returning to FIG. 2, the display control unit 32 refers to the information included in each object, and controls the display of content and a target of communication. As one way of control, the display control unit 32 switches, according to specification of a group by a user, the display states of the content and the target of communication associated with the specified group, based on the group information held by the group information holding unit 31.

Moreover, the display control unit 32 may control display of content or a target of communication such that the color set for a category group with which the content or the target of communication is associated is displayed in the area where the content or the target of communication is displayed.

The object management unit 33 manages the state of each object. Management of the state of an object includes cancellation of association of content or a target of communication with a category group. That is, the operation of the object management unit 33 includes an operation corresponding to the operation of an association cancellation unit according to the present invention.

Moreover, the display control unit 32 may control display of content or a target of communication such that a category group with which the content or the target of communication is associated and a receiving unit for receiving cancellation of association with the category group are displayed in the area where the content or the target of communication is displayed. Then, the object management unit 33 may cancel, in response to an operation on the receiving unit, the association with a category group related to the operation.

At the time of starting exchange of content with a target of communication, the communication confirmation unit 34 confirms whether or not the exchange is to be performed, by determining whether or not the content related to the exchange and the target of communication are associated with the same group.

Additionally, in the case it is determined that the content related to the exchange and the target of communication are not associated with the same category group, the communication confirmation unit 34 may confirm whether or not to perform the exchange, by receiving a response regarding whether or not to allow the exchange.

Furthermore, the information processing apparatus 1 includes an APIs (SNSaAPI, SNSbAPI) for each SNS. The API is used to display on the dashboard in a timeline the substances of communication on the SNS.

<Example Screen>

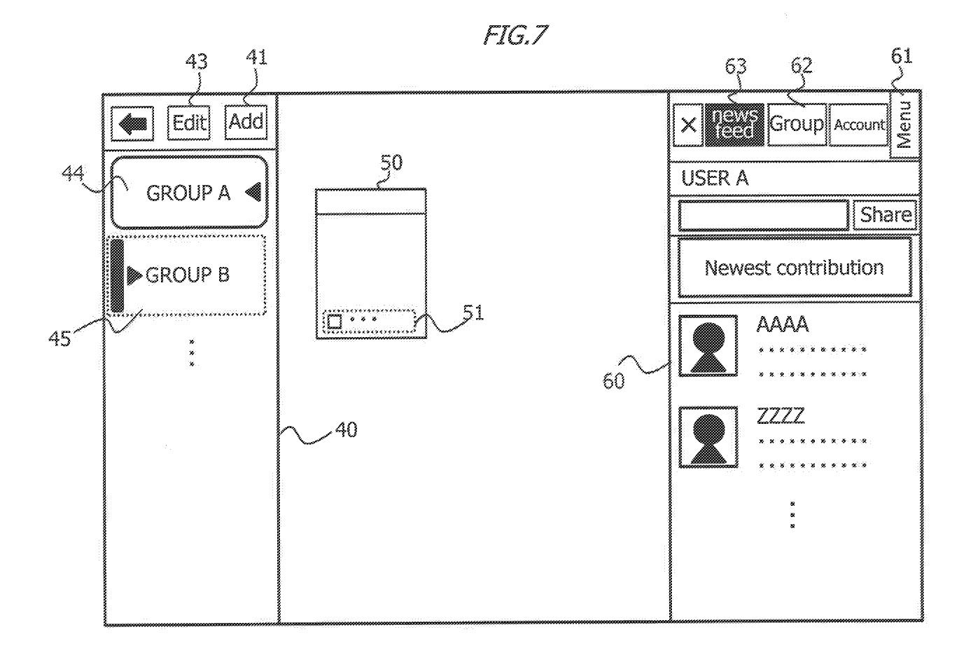

FIG. 7 illustrates an example of a screen that is displayed by the output device 15 according to the present embodiment. The display control unit 32 refers to the information included in each object, and controls display of the screen illustrated in FIG. 7.

Information about a category group is displayed in an area 40. The display control unit 32 refers to the category group object 21 held in the group information holding unit 31, and identifies information to be displayed in the area 40.

For example, the display control unit 32 displays a category group identified based on each category group object 21 in the area 40. In the example illustrated in FIG. 7, a category group named “group A” is displayed in an area 44, and a category group named “group B” is displayed in an area 45. Additionally, the name of each category group is identified based on the category group name included in the category group object 21 corresponding to the category group.

Buttons 41 and 43 are buttons used for receiving an operation of a user regarding the category group. The button 41 is a button for receiving an operation of adding a category group. The button 43 is a button for receiving an operation of editing the state of a category group that is set. Furthermore, each of the areas 44 and 45 also functions as a button for switching the display state of a corresponding category group.

A user operates these buttons by using the input device 13 to create a new category group or to update the state of an already existing category group, for example. The object management unit 33 updates the state of a category group object 21 which is the target of the operation according to the operation or the like on these buttons.

For example, the user may switch the display state of group A from “display” to “non-display” or from “non-display” to “display” by operating the area 44 that functions as a button using the input device 13. At this time, the object management unit 33 updates the group display state included in the category group object 21 corresponding to group A in response to the operation.

Moreover, in the example illustrated in FIG. 7, the display state of group A is set to “display”, and the display state of group B is set to “non-display”. Also, the color set for group A is “white”, and the color set for group B is “black”. In the example illustrated in FIG. 7, the area 44 and the area 45 are set to the colors set for respective category groups in the case the display states of the category groups are set to “display”.

Content is displayed in an area 50. The display control unit 32 refers to the content coordinate information included in the content object 22 corresponding to the content displayed in the area 50, and identifies the coordinates and the size of the area 50.

Also, the color set for the category group to which the content belongs is displayed in an area 51. Specifically, rectangles of the colors set for the category groups to which the content belongs are listed in the area 51. The display control unit 32 refers to the category group object list included in the content object 22 corresponding to the content displayed in the area 50. Then, the display control unit 32 refers to the category group colors of the category group objects 21 included in the category group object list which has been referred to, and identifies the colors of rectangles to be displayed in the area 51.

Information related to a target of communication is displayed in an area 60. In the present embodiment, people or the substance on a dashboard are displayed in the area 60 according to specification by a user. The display control unit 32 refers to the people object 24 or the dashboard object 25 in response to the specification by a user, and identifies the information to be displayed in the area 60. Incidentally, in the example in FIG. 7, the substance on the dashboard is displayed in the area 60. Specifically, the substance of communication performed on the SNS is displayed in a timeline in the area 60.

A button 61 is a button for switching the information to be displayed in the area 60. A user may specify the people or the dashboard by operating the button 61 using the input device 13. The display control unit 32 refers to the people object 24 or the dashboard object 25 in response to the specification by the user, and controls the display of the target of communication such that the people or the substance on the dashboard is displayed in the area 60.

Buttons 62 and 63 are buttons used for selecting the substance on the dashboard that is to be displayed in the area 60. When the button 62 is selected, an SNS group on the SNS connected to the dashboard is displayed in the area 60. On the other hand, when the button 63 is selected, the substance of communication that is being performed on an SNS connected to the dashboard is displayed in the area 60 in a timeline. Additionally, in the example illustrated in FIG. 7, the button 63 is selected.

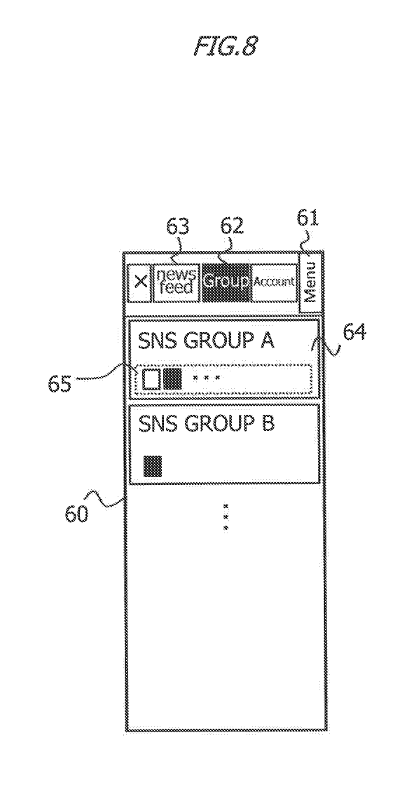

FIG. 8 illustrates an example of a display of the substance (an SNS group) on a dashboard according to the present embodiment. FIG. 8 illustrates information that is to be displayed in the area 60 in the case the button 62 is selected. Information related to each SNS group is displayed in an area 64. Also, the color that is set for a category group with which each SNS group is associated is displayed in an area 65. In the present embodiment, as with the area 51, a rectangle of the category group color of a category group with which an SNS group is associated is displayed in the area 65.

Additionally, in the example illustrated in FIG. 8, SNS group A is associated with category groups “group A” and “group B”. On the other hand, SNS group B is associated with category group “group B”. Accordingly, in the case the display state of group A is “display” and the display state of group B is “non-display”, SNS group A is displayed, but SNS group B is not displayed.

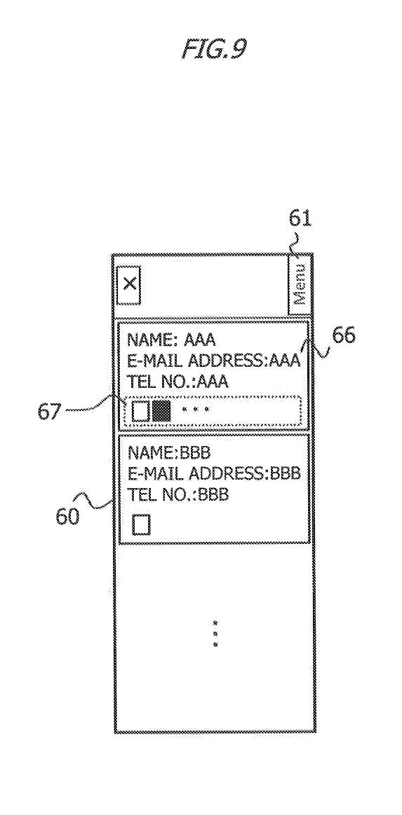

FIG. 9 illustrates an example of a display of details of the people according to the present embodiment. Name, email address, telephone number and the like are displayed in an area 66. These pieces of information are acquired from the name and the property information included in the people object 24. Furthermore, the color set for a category group with which the people are associated is displayed in an area 67. In the present embodiment, as with the areas 51 and 65, a rectangle of the category group color of a category group with which the people are associated is displayed in the area 67. Moreover, the category group with which the target people are associated is identified based on the category group object list included in the people object 24.

Additionally, as illustrated in FIGS. 7 to 9, the content, the dashboard and the people are displayed as windows, for example. In the present embodiment, a user may drag these windows using the input device 13 and drop them in areas where category groups are displayed to thereby perform association with these category groups.

On the other hand, in order to cancel the category group, the display control unit 32 may control display of content or a target of communication such that a category group associated with the content or the target of communication and a receiving unit for receiving cancellation of association with the category group are displayed in an area where the content or the target of communication is displayed.

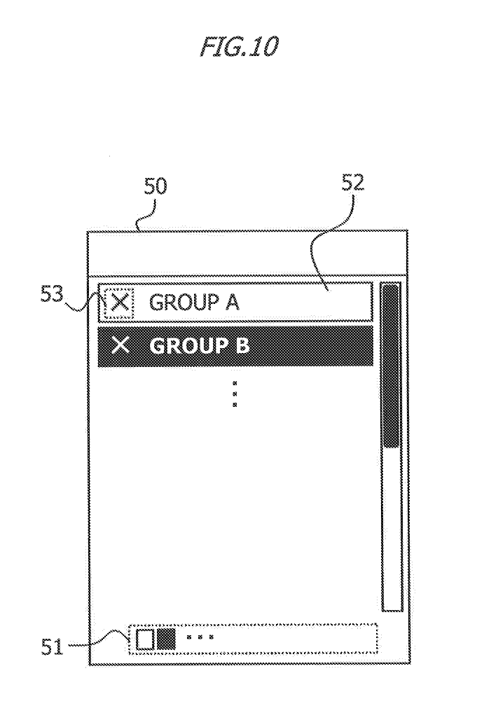

FIG. 10 illustrates an example of a display at the time of cancellation of content from a category group according to the present embodiment. The name of a category group with which content displayed in the area 50 is associated is displayed in an area 52. A receiving unit 53 for receiving cancellation of association with a category group is displayed in the area 52.

In the example illustrated in FIG. 10, text “group A” is displayed in the area 52 as the name of a category group. In this example, when a user operates the receiving unit 53 using the input device 13, association of content with group A is cancelled. For example, the object management unit 33 deletes, in response to the operation, the category group object corresponding to group A from the category group object list included in the content object 22 corresponding to the content. Cancellation of association with a category group is performed in this manner.

Additionally, the method of cancelling association of a target of communication with a category group can be described in the same manner as for the content. Therefore, an explanation on the method of cancelling association of a target of communication with a category group will be omitted.

§2 Example Operation

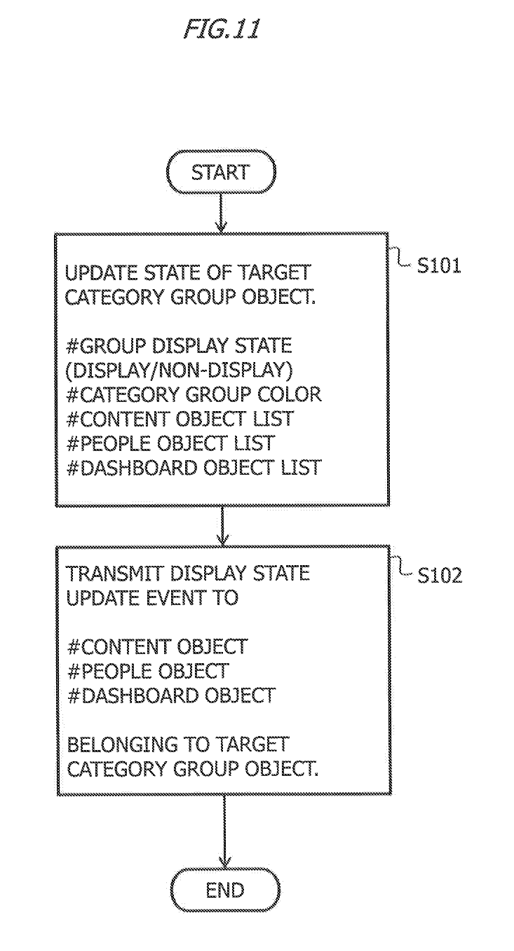

An example operation of the information processing apparatus 1 according to the present embodiment will be described with reference to FIGS. 11 to 16. Additionally, the procedure according to the example operation described below is merely an example, and the order of processing may be changed where possible as in a case where there is no temporal relationship, such as using the result of previous processing. Moreover, in each drawing, step is expressed by “S”.

<Update of State of Category Group>

FIG. 11 illustrates an example of a procedure regarding update of a state of a category group object by the information processing apparatus 1 according to the present embodiment.

In step 101, the state of a category group object which is the target of processing is updated by the object management unit 33. As described with reference to FIGS. 7 to 10, a user switches the display state of a category group, associates content, a dashboard (an SNS group) or people with the category group, or cancels the association, by performing an operation on a screen using the input device 13. The object management unit 33 updates the state of a category group object 21 corresponding to the category group which is the target of processing in response to the operation.

For example, in the case the user has performed an operation of switching the display state of group A from “non-display” to “display”, the object management unit 33 updates the value of the group display state included in the category group object corresponding to group A from “non-display” to “display”.

Also, for example, in the case the user has performed an operation of associating SNS group A with group A, the object management unit 33 adds the SNS group object corresponding to SNS group A to the SNS group object list included in the category group object 21 corresponding to group A. Also, the object management unit 33 adds the dashboard object 25 corresponding to the dashboard used for displaying the substance of communication in SNS group A to the dashboard object list included in the category group object 21.

As described, the object management unit 33 updates the group display state or the like included in the category group object 21 which is the target of processing according to the specifics of the operation of the user. The state of the category group object 21 which is the target of processing thereby falls into a state desired by the user.

Additionally, the information processing apparatus 1 may receive an operation of changing the category group name or the category group color. In this case, the object management unit 33 updates the value of the category group name or the category group color included in the category group object 21 which is the target of processing in response to the operation.

In the next step 102, a display state update event is transmitted by the object management unit 33 to the content object 22, the people object 24 and the dashboard object 25 belonging to the category group object 21 which is the target of processing in step 101. For example, the object management unit 33 refers to the content object list, the people object list and the dashboard object list included in the category group object 21 which is the target of processing in step 101. Then, the object management unit 33 transmits a display state update event to the content object 22, the people object 24 and the dashboard object 25 included in the lists.

The process related to the update of state of the category group object is ended with this processing. Additionally, update of the display state is performed at each object which has received the display state update event by the procedure described below.

<Deletion of Category Group>

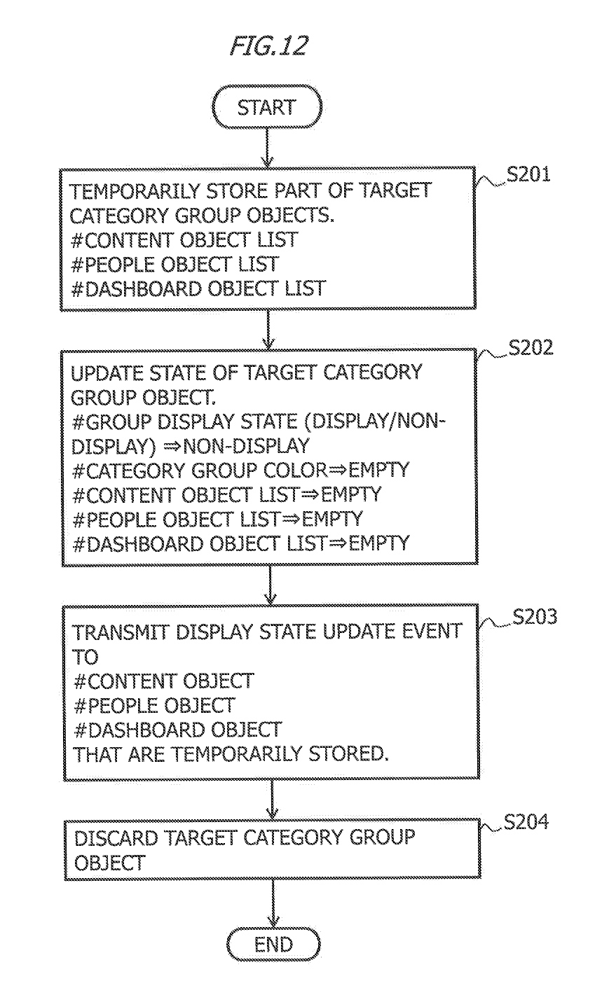

FIG. 12 illustrates an example of a procedure regarding deletion of a category group by the information processing apparatus 1 according to the present embodiment. When a user performs an operation regarding deletion of a category group, the process related to deletion of the category group is started.

In step 201, content, people and dashboard belonging to a category group which is the target of deletion are temporarily stored by the object management unit 33. For example, the object management unit 33 acquires the content object list, the people object list and the dashboard object list included in the category group object 21 corresponding to the category group which is the target of deletion. Then, the object management unit 33 stores each of the acquired list in the RAM of the control unit 11.

In step 202, the state of the category group object 21 corresponding to the category group which is the target of deletion is updated by the object management unit 33. For example, as this update, the object management unit 33 updates the group display state included in the category group object 21 to “non-display”, the value of the category group color to be empty, the content object list to be empty, the people object list to be empty, the dashboard object list to be empty, and the SNS group object list to be empty.

In step 203, a display state update event is transmitted by the object management unit 33 to the object included in each list stored in step 201. The object management unit 33 refers to each list stored in the RAM, and transmits the display state update event to the content object 22, the people object 24 and the dashboard object 25 included in each list. The display state is updated by the procedure described later at each object which has received the display state update event. Additionally, the object management unit 33 may delete each list stored in the RAM after the process of step 203 has ended.

In step 204, the category group object 21 corresponding to the category group which is the target of deletion is discarded by the object management unit 33. The process related to deletion of the category group is thus completed.

<Update of Display State of Content>

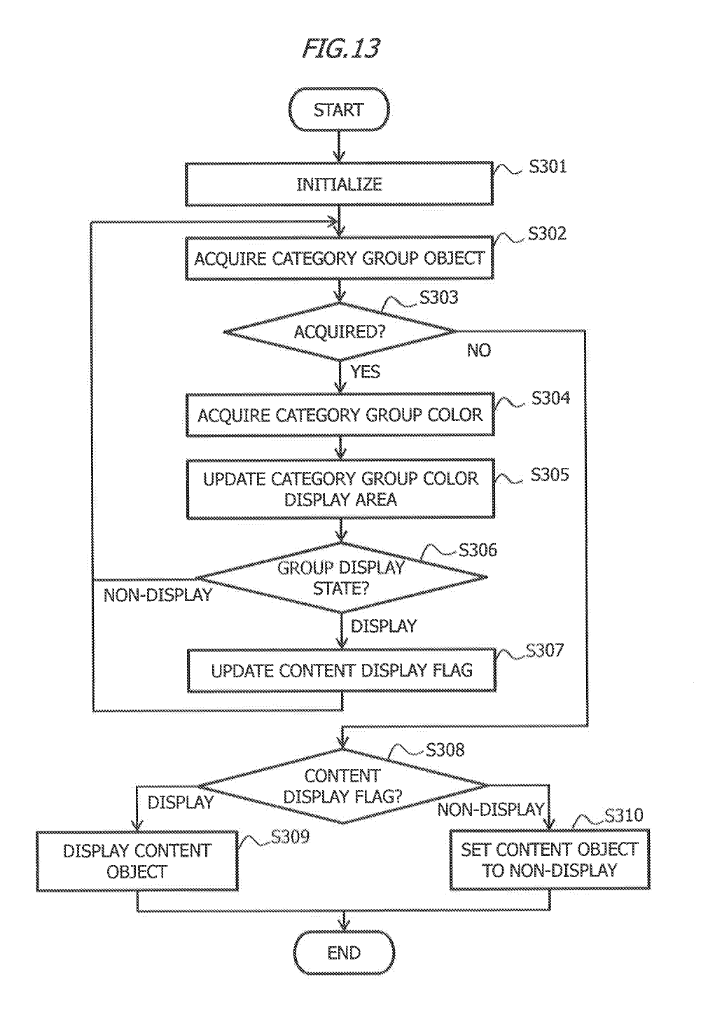

FIG. 13 illustrates an example of a procedure regarding update of a display state of content by the information processing apparatus 1 according to the present embodiment. In the process related to state update or deletion of a category group described above, a display state update event is transmitted to the content object 22 that is associated with the category group object 21 which is the target of state update or deletion. This process is performed on the content object 22 which has received the display state update event.

In step 301, initialization is performed at the content object 22 which is the target of processing. For example, the display control unit 32 initializes the content display flag included in the content object 22 which is the target of processing to “non-display”.

The processes of steps 302 to 307 are processes for deciding the display state of the content corresponding to the content object 22 which is the target of processing. These processes are repeated until no more category group object 21 is acquired from the category group object list included in the content object 22 by the determination process of step 303.

In step 302, the display control unit 32 acquires one category group object 21 from the category group object list included in the content object 22 which is the target of processing. Additionally, in the case the processes of steps 302 to 307 are repeated, the display control unit 32 acquires the category group object 21 other than the category group object 21 which has been acquired once in step 302.

In step 303, a process of determining whether or not the display control unit 32 has succeeded in acquiring a category group object 21 in step 302 is performed. In the case the display control unit 32 has succeeded in acquiring a category group object 21 in step 302, the process proceeds to step 304. On the other hand, in the case the display control unit 32 has failed in acquiring a category group object 21 in step 302, the process proceeds to step 308.

In step 304, the category group color included in the category group object 21 acquired in step 302 is acquired by the display control unit 32. Then, the process proceeds to step 305.

In step 305, the category group color acquired in step 304 is added by the display control unit 32 to the category group color display area information included in the content object 22 which is the target of processing. As described above, the processes of step 302 to 307 are repeated until no more category group object 21 is acquired from the category group object list included in the content object 22 which is the target of processing. In other words, the processes of steps 302 to 307 are repeated until all the category groups to which the content belongs have been referred to. Therefore, with the process of step 305 being repeated, all the category group colors of the category groups to which the target content belongs are added to the category group color display area information of the target content. The display control unit 32 is thereby enabled to display rectangles of the category group colors of the category groups to which the content belongs in the area 51.

In step 306, the display control unit 32 refers to the group display state included in the category group object 21 acquired in step 302. Then, in the case the group display state which has been referred to is “display”, the display control unit 32 proceeds with the process to step 307. On the other hand, in the case the group display state which has been referred to is “non-display”, the display control unit 32 returns the process to step 302.

In step 307, the display control unit 32 updates the content display flag included in the content object 22 which is the target of processing to “display”. Then, the process returns to step 302.

Additionally, in step 301, the content display flag included in the content object 22 which is the target of processing is initialized to “non-display”. Accordingly, the content which is the target of processing becomes displayed by the content display flag being updated to “display” by the processing of step 307. That is, if there is even one category group whose display state is “display” among the category groups to which the content which is the target of processing belongs, the processing of step 307 is performed and the content is displayed.

In step 308, the display control unit 32 refers to the content display flag included in the content object 22 which is the target of processing. Then, in the case the content display flag which has been referred to is “display”, the display control unit 32 proceeds with the process to step 309. On the other hand, in the case the content display flag which has been referred to is “non-display”, the display control unit 32 proceeds with the process to step 310.

In step 309, the display control unit 32 displays the content corresponding to the content object 22 which is the target of processing. In this case, the display control unit 32 refers to the content coordinate information included in the content object 22 which is the target of processing, and identifies the coordinates and the size of the area 50 where the content is to be displayed. Also, the display control unit 32 refers to the category group color display area information included in the content object 22 which is the target of processing, and identifies the number of rectangles to be displayed in the area 51 and their colors. On the other hand, in step 310, the display control unit 32 sets the content corresponding to the content object 22 which is the target of processing to non-display.

The process of updating the display state for the content object 22 which has received a display state update event is thereby ended. In the present embodiment, the display of target content is controlled in this manner.

<Update of Display State of People>

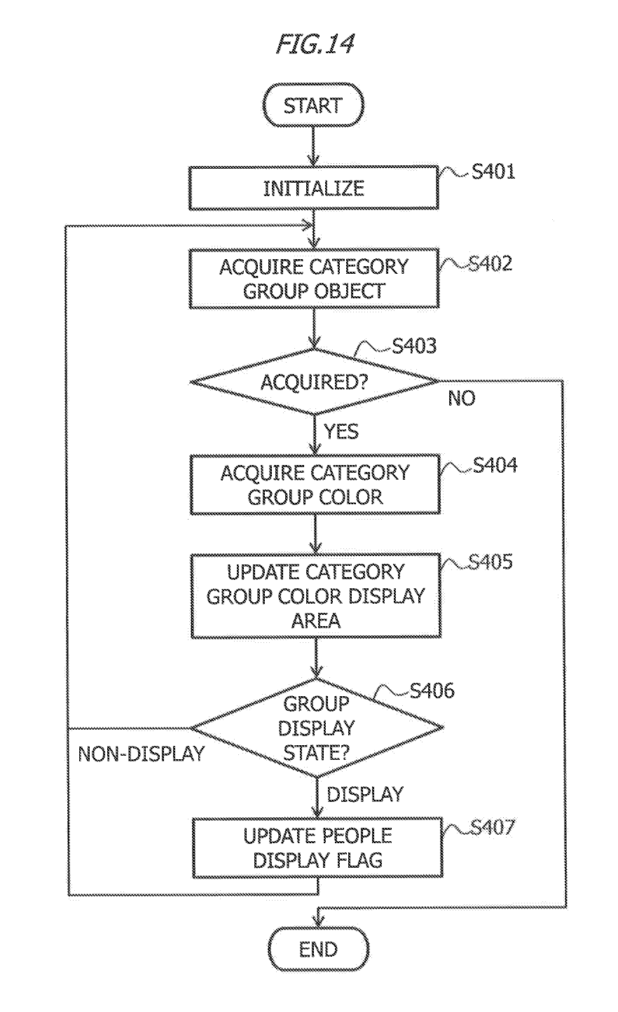

FIG. 14 illustrates an example of a procedure regarding update of a display state of people by the information processing apparatus 1 according to the present embodiment. In the process related to state update or deletion of a category group described above, a display state update event is transmitted to the people object 24 that is associated with the category group object 21 which is the target of state update or deletion. This processing is performed on the people object 24 which has received the display state update event.

In step 401, initialization is performed at the people object 24 which is the target of processing. For example, the display control unit 32 initializes the people display flag included in the people object 24 which is the target of processing to “non-display”.

Like steps 302 to 307 described above, the processes of steps 402 to 407 are processes for deciding the display state of the people corresponding to the people object 24 which is the target of processing. These processes are repeated until no more category group object 21 is acquired from the category group object list included in the people object 24 by the determination process of step 403.

In step 402, the display control unit 32 acquires one category group object 21 from the category group object list included in the people object 24 which is the target of processing. Additionally, in the case the processes of steps 402 to 407 are repeated, the display control unit 32 acquires the category group object 21 other than the category group object 21 which has been acquired once in step 402.

In step 403, a process of determining whether or not the display control unit 32 has succeeded in acquiring a category group object 21 in step 402 is performed. In the case the display control unit 32 has succeeded in acquiring a category group object 21 in step 402, the process proceeds to step 404. On the other hand, in the case the display control unit 32 has failed in acquiring a category group object 21 in step 402, the update process for the display state for the people object 24 which is the target of processing is ended.

In step 404, the category group color included in the category group object 21 acquired in step 402 is acquired by the display control unit 32. Then, the process proceeds to step 405.

In step 405, the category group color acquired in step 404 is added by the display control unit 32 to the category group color display area information included in the people object 24 which is the target of processing. As with step 305 described above, the display control unit 32 is enabled by step 405 to display a rectangle of the category group color of the category group to which the people belong in the area 67.

In step 406, the display control unit 32 refers to the group display state included in the category group object 21 acquired in step 402. Then, in the case the group display state which has been referred to is “display”, the display control unit 32 proceeds with the process to step 407. On the other hand, in the case the group display state which has been referred to is “non-display”, the display control unit 32 returns the process to step 402.

In step 407, the display control unit 32 updates the people display flag included in the people object 24 which is the target of processing to “display”. Then, the process returns to step 402.

Additionally, like step 307 described above, if there is even one category group whose display state is “display” among the category groups to which the people which are the target of processing belong, the processing of step 407 is performed and the people are displayed.

The display state of the people object 24 which has received a display state update event is updated in this manner. Additionally, the update process for the people panel 23 is performed after the update process for the display state of all the people objects 24 which have received the display state update event has been completed.

For example, the display control unit 32 initializes and empties the list of people to be displayed included in the people display area information of the people panel 23. Then, the display control unit 32 refers to the people object list included in the people panel 23, and adds the people corresponding to the people object 24 whose people display flag is “display” to the people display area information. People whose display state is “display” are thereby displayed in the area 60. In the present embodiment, the display of target people is controlled in this manner.

<Update of Display State of Dashboard>

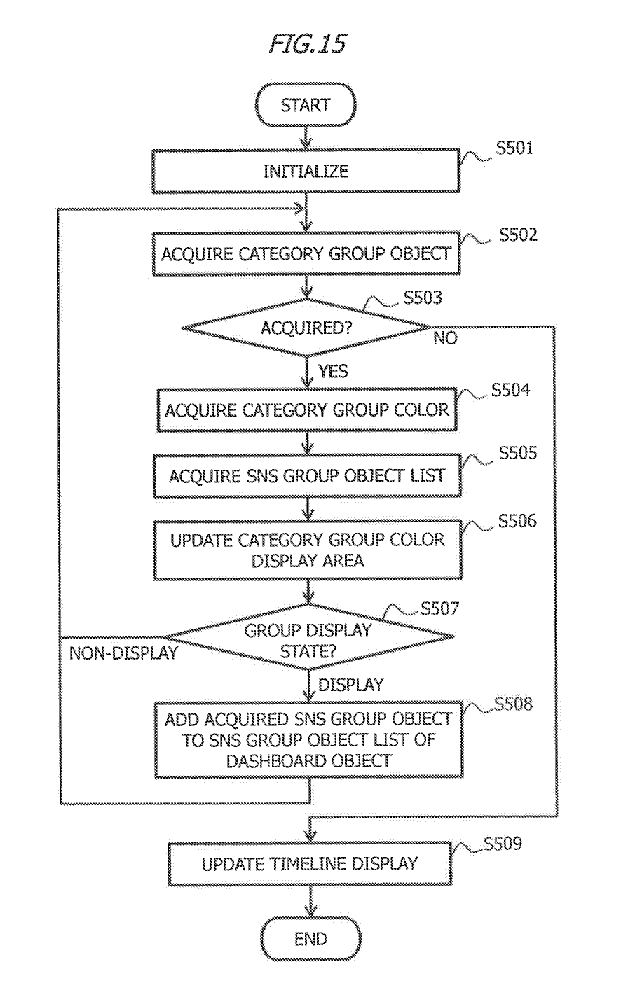

FIG. 15 illustrates an example of a procedure regarding update of a display state of a dashboard object by the information processing apparatus 1 according to the present embodiment. In the process related to state update or deletion of a category group described above, a display state update event is transmitted to the dashboard object 25 that is associated with the category group object 21 which is the target of state update or deletion. This processing is performed on the dashboard object 25 which has received the display state update event.

In step 501, initialization is performed at the dashboard object 25 which is the target of processing. For example, the display control unit 32 empties the SNS group object list of the dashboard object 25 which is the target of processing.

Furthermore, the display control unit 32 refers to the category group object list of the dashboard object 25 which is the target of processing. Next, the display control unit 32 refers to the SNS group object list of the category group object 21 included in the category group object list which has been referred to. Then, the display control unit 32 resets the information about the category group color included in the category group color display area information of the SNS group object included in the SNS group object list which has been referred to. That is, the display control unit 32 resets the category group color display area information of all the SNS group objects related to the dashboard which is the target of processing.

Like steps 302 to 307 described above, the processes of steps 502 to 508 are processes for deciding the display state of a dashboard corresponding to the dashboard object 25 which is the target of processing. These processes are repeated until no more category group object 21 is acquired by the determination process of step 502 from the category group object list included in the dashboard object 25.

In step 502, the display control unit 32 acquires one category group object 21 from the category group object list included in the dashboard object 25 which is the target of processing. Additionally, in the case the processes of steps 502 to 508 are repeated, the display control unit 32 acquires the category group object 21 other than the category group object 21 which has been acquired once in step 502.

In step 503, a process of determining whether or not the display control unit 32 has succeeded in acquiring a category group object 21 in step 502 is performed. In the case the display control unit 32 has succeeded in acquiring a category group object 21 in step 502, the process proceeds to step 504. On the other hand, in the case the display control unit 32 has failed in acquiring a category group object 21 in step 502, the process proceeds to step 509.

In step 504, the category group color included in the category group object 21 acquired in step 502 is acquired by the display control unit 32. Then, the process proceeds to step 505.

In step 505, the SNS group object list included in the category group object 21 acquired in step 502 is acquired by the display control unit 32. Then, the process proceeds to step 506.

In step 506, the category group color acquired in step 504 is added by the display control unit 32 to the category group color display area information of the SNS group object included in the SNS group object list acquired in step 505. As with steps 305 and 405 described above, the display control unit 32 is enabled by step 506 to display a rectangle of the category group color of the category group to which the SNS group belongs in the area 65.

In step 507, the display control unit 32 refers to the group display state included in the category group object 21 acquired in step 502. Then, in the case the group display state which has been referred to is “display”, the display control unit 32 proceeds with the process to step 508. On the other hand, in the case the group display state which has been referred to is “non-display”, the display control unit 32 returns the process to step 502.

In step 508, the display control unit 32 adds the SNS group object included in the SNS group object list acquired in step 505 to the SNS group object list of the dashboard object 25 which is the target of processing. Then, the process returns to step 502.

Here, in the case the SNS group object to be added to the SNS group object list of the dashboard object 25 which is the target of processing already exists, the display control unit 32 does not add the SNS group object. That is, the display control unit 32 does not add an overlapping SNS group object.

Additionally, like steps 307 and 407 described above, if there is even one category group whose display state is “display” among the category groups to which the dashboard which is the target of processing belongs, the processing of step 508 is performed and the SNS group related to the dashboard which is the target of processing is displayed. Also, the substance of communication performed in an SNS group belonging to a category group whose display state is “display” is displayed on the dashboard which is the target of processing.

In step 509, the timeline display is updated by the display control unit 32. For example, the display control unit 32 refers to the SNS group object list of the dashboard object which is the target of processing. Then, the display control unit 32 updates the timeline display so as to display the substance of communication performed in the SNS group object included in the SNS group object list which has been referred to, or in other words, the SNS group belonging to the category group whose display state is “display”.

At this time, the display control unit 32 refers to the SNS identifier of the dashboard object which is the target of processing, and identifies the SNS connected to the dashboard. Then, the display control unit 32 uses the API of the identified SNS to perform timeline display.

The display state of the dashboard object 25 which has received a display state update event is updated in this manner. In the present embodiment, display of an SNS group and the timeline display are controlled in this manner.

<Confirmation of Exchange of Content>

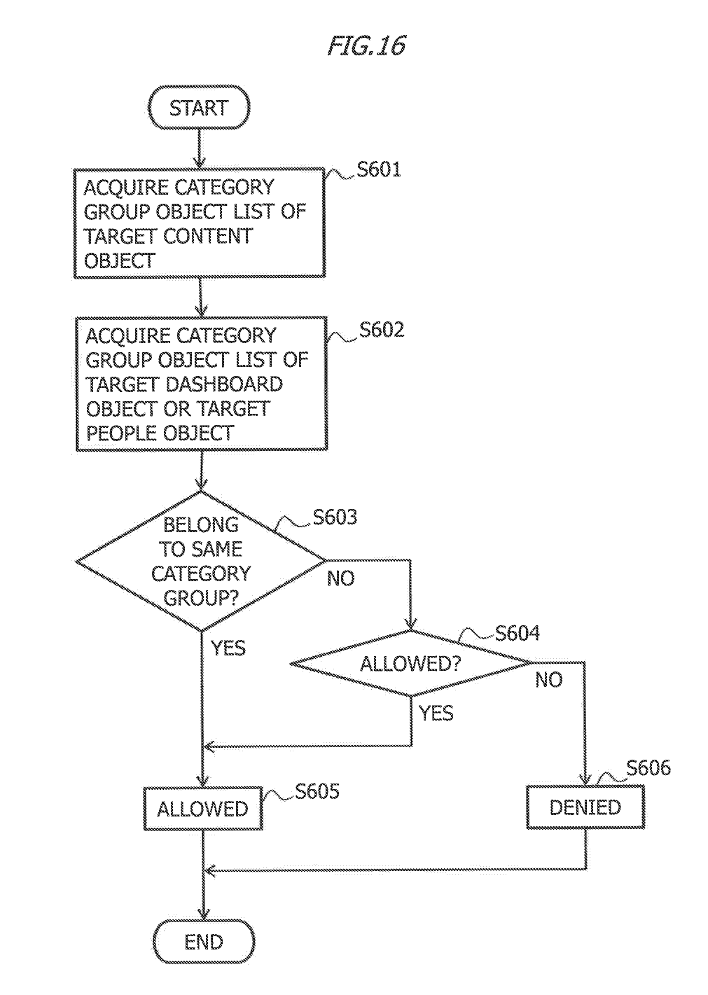

FIG. 16 illustrates an example of a procedure regarding confirmation of content exchange by the information processing apparatus 1 according to the present embodiment. For example, the present process is performed at the time of a user trying to transmit, using the screen illustrated in FIG. 7, content 50 related to a job to a target of communication based on an SNS group or people displayed in the area 60.

In step 601, the communication confirmation unit 34 acquires the category group object list of the content object 22 corresponding to the content which is the target of exchange.

In step 602, the communication confirmation unit 34 acquires the category group object list related to the target of communication to which the content is to be transmitted.

For example, it is assumed that the user tried to transmit content during communication in an SNS group. In this case, the communication confirmation unit 34 acquires the category group object list of the dashboard object 25 corresponding to the dashboard on which the communication is being performed.

Also, for example, it is assumed that the user tried to transmit content using people. In this case, the communication confirmation unit 34 acquires the category group object list of the people object 24 corresponding to the people being used.

In step 603, the communication confirmation unit 34 determines whether or not the content related to the exchange and the target of communication are associated with the same category group.

For example, the communication confirmation unit 34 checks the category group object list acquired in step 601 and the category group object list acquired in step 602 against each other. The communication confirmation unit 34 determines by this checking whether or not the same category group object is included in the category group object list acquired in step 601 and the category group object list acquired in step 602.

In the case the same category group object is included in the category group object lists acquired in the respective steps, the communication confirmation unit 34 determines that the content related to the exchange and the target of communication are associated with the same category group. In this case, the process proceeds to step 605.

On the other hand, in the case the same category group object is not included in the category group object lists acquired in the respective steps, the communication confirmation unit 34 determines that the content related to the exchange and the target of communication are not associated with the same category group. In this case, the process proceeds to step 604.

In step 604, a response regarding whether or not to allow exchange of target content is received by the communication confirmation unit 34. A user gives the response using the input device 13. In the case the user has selected to allow the carrying out of the exchange, the communication confirmation unit 34 proceeds with the process to step 605. On the other hand, in the case the user has selected to not allow the carrying out of the exchange, the communication confirmation unit 34 proceeds with the process to step 606.

In step 605, exchange of target content is allowed by the communication confirmation unit 34. Carrying out of transmission of the content 50 related to a job to the target of communication is thereby started. The process related to confirmation of exchange of the content is thus ended.

In step 606, exchange of target content is denied by the communication confirmation unit 34. Carrying out of transmission of the content 50 related to a job to the target of communication is thereby stopped. The process related to confirmation of exchange of the content is thus ended.

§3 Supplement

Heretofore, an embodiment of the present invention has been described in detail, but the description above is merely an example of the present invention in every aspect, and does not limit the scope of the invention. It is needless to say that various modifications and alterations are possible without departing from the scope of the present invention.

According to the information processing apparatus according to an aspect of the present invention, the group set for a job is associated with the content being the target of the job and the target of communication being related to the job. The display states of the content and the target of communication associated with the specified group is switched in response to specification of a group.

Therefore, according to the information processing apparatus according to an aspect of the present invention, it is able to switch, in a lump, the display state the contents and the target of communication associated with the group.

According to an aspect of the present invention, the efficiency of switching between jobs including communication can be increased.

What is claimed is:

1. An information processing apparatus comprising:
a group information holding unit that holds group information for identifying content and a target of communication which are associated with a group set for a job, the content being a target of the job, the target of communication being related to the job; and
a display control unit that switches, in response to specification of a group, display states of the content and the target of communication associated with the specified group based on the group information.

2. The information processing apparatus according to claim 1, wherein the display control unit controls display of the content or the target of communication such that a color set for a group with which the content or the target of communication is associated is displayed in an area where the content or the target of communication is displayed.

3. The information processing apparatus according to claim 1, further comprising:
an association cancellation unit that cancels association of the content or the target of communication with the group,
wherein the display control unit controls display of the content or the target of communication such that a group associated with the content or the target of communication and a receiving unit that receives cancellation of association with the group are displayed in an area where the content or the target of communication is displayed, and
wherein the association cancellation unit cancels, in response to an operation on the receiving unit, association with a group related to the operation.

4. The information processing apparatus according to claim 1, further comprising:
a communication confirmation unit that confirms, at a start of an exchange of the content with the target of communication, whether or not to carry out the exchange, by determining whether or not the content and the target of communication related to the exchange are associated with a same group.

5. The information processing apparatus according to claim 4, wherein, in a case the content and the target of communication related to the exchange are determined to be not associated with a same group, the communication confirmation unit receives a response regarding whether or not the exchange is to be allowed and confirms whether or not to carry out the exchange.

6. An information processing method performed by a computer, comprising:
holding group information for identifying content and a target of communication which are associated with a group set for a job, the content being a target of the job, the target of communication being related to the job; and
switching, in response to specification of a group, display states of the content and the target of communication associated with the specified group based on the group information.

7. A non-transitory computer-readable recording medium that records a program for causing a computer to perform:
holding group information for identifying content and a target of communication which are associated with a group set for a job, the content being a target of the job, the target of communication being related to the job; and
switching, in response to specification of a group, display states of the content and the target of communication associated with the specified group based on the group information.
